(19) United States
(12) Patent Application Publication
(10) Pub. No.: US 2025/0155585 A1
(43) Pub. Date: May 15, 2025

(54) POSITION DETERMINATION OF A VEHICLE

(71) Applicant: Ford Global Technologies, LLC, Dearborn, MI (US)

(72) Inventors: Mohsen Lakehal-Ayat, Aachen/NRW (DE); Urs Christen, Aachen/NRW (DE); Ahmed Benmimoun, Aachen/NRW (DE)

(73) Assignee: Ford Global Technologies, LLC, Dearborn, MI (US)

(21) Appl. No.: 18/947,340

(22) Filed: Nov. 14, 2024

(30) Foreign Application Priority Data
Nov. 15, 2023 (DE) 102023131843.8

(51) Int. Cl. G01S 19/40; G01S 19/45; G01S 19/52

(52) U.S. Cl. CPC G01S 19/40; G01S 19/45; G01S 19/52

(57) ABSTRACT

A vehicle has a navigation sensor, a communication device, and a control device. A position signal of a global navigation satellite system is received by the navigation sensor. An estimated vehicle position is determined by the control device based on the at least one received position signal. An estimated relative velocity of the vehicle is determined with respect to the GNSS by the control device at least based on multiple received position signals of the GNSS. Correction values for the estimated vehicle position and the estimated relative velocity are received by the control device from a server based on the communication device. A corrected vehicle position and a corrected relative velocity are determined by the control device based on the received correction values. At least one of a pseudo-range, a Doppler shift, and a measured vehicle velocity are taken into consideration here by the control device.

### CROSS-REFERENCE TO RELATED APPLICATION

This patent application claims priority to German Application No. DE 102023131843.8 filed on Nov. 15, 2023, which is hereby incorporated by reference in its entirety.

### BACKGROUND

Current devices for position determination are based on a global navigation satellite system (GNSS), which supplies raw measurements for calculating the vehicle position. Many factors, such as the respective satellite geometry, possible signal blocking of the direct signal path, and ionospheric disturbances, and respective atmospheric conditions or other things reduce the accuracy of the position determined by the receiver on the basis of the received signals, however. The position accuracy is thus limited if it is only based on the raw measurements. The position inaccuracy is then between 3 m and 5 m. For advanced applications, such as automatic lane change assistants or anonymous driving functions, these position inaccuracies are excessively large.

Making the position determination more precise by determining offsets (correction values) using differential algorithms with respect to the collected signals of the navigation satellites is known according to the prior art. The correction values are determined by receivers in that a reference to sufficiently accurately known locations is established. Such receivers having sufficiently accurate location data are referred to as reference stations or base stations. Third-party providers who base themselves on their own network of reference receivers offer corresponding correction data for various users as services. Ensuring a corresponding position accuracy is thus linked to a high expenditure, however.

In addition, a majority of the existing vehicles do have navigation signal receivers, but are not equipped with corresponding communication means in order to be able to receive the generally available correction data at all. This has been limited up to this point to less specialized vehicles.

US 2022/0299657 A1 discloses increasing the position accuracy by determining a correction value which is used in differential algorithms. Moreover, the correction value is transmitted between a large number of devices, at least one of which knows its own location sufficiently accurately. The approach is therefore based, however, on providing at least one specialized component, the position of which is known sufficiently precisely.

U.S. Pat. No. 11,480,691 B2 discloses determining a position relative to a roadside unit or another reference point located nearby. Vehicles which are located in a previously defined area or in transmission distance or in another geographic proximity to such a roadside unit can jointly use navigation signal data by using transmitted messages or other messages which are transmitted by the vehicles and/or the roadside unit. However, a high expenditure is thus caused, since separate roadside units have to be provided.

U.S. Pat. No. 9,020,755 B1 discloses a method for determining the position of a moving vehicle. A global position is detected by a navigation device of at least one parked vehicle in the vicinity of the moving vehicle. The global position is determined as a function of signals which are transmitted by a large number of satellites. The errors connected to the emitted signals are determined. A correction value is determined. The correction value is transmitted to the driving vehicle. The applications are thus limited, since a stationary vehicle is always required.

U.S. Pat. No. 11,300,685 B2 discloses providing correction data for the position determination. For this purpose, position data are determined as a function of an incoming GNSS signal and/or made available to a vehicle. The vehicle has a GNSS receiver or a differential GNSS (DGNSS) receiver for receiving the incoming GNSS signal. The position data are determined when the vehicle is located in a charging position at a predefined charging station. Position data are also additionally determined and/or made available which are representative for a global position of the predefined charging station. Correction values are determined and applied as a function of the data. The applications are also limited with this approach, since correction values are only determined in special situations (in/at a charging station).

### BRIEF DESCRIPTION OF THE DRAWINGS

The disclosure and further advantageous examples and refinements thereof are described in more detail and explained hereinafter on the basis of the examples shown in the drawings. In the figures:

FIG. 1 shows a simplified schematic representation of a vehicle,

FIG. 2 shows a simplified schematic representation of an application scenario,

FIG. 3 shows a simplified schematic representation of a flow chart,

FIG. 4 shows a simplified schematic representation of a method, and

FIG. 5 shows a simplified schematic representation of a further application scenario.

### DETAILED DESCRIPTION

There is a need to eliminate or at least to reduce the disadvantages of known methods and systems for correcting positions and making them more precise. In particular, there is a need to provide a method for determining a position of a vehicle, a control system, and a vehicle which open up a broad area of application and enable accurate position determination and correction with an expenditure reduced in relation to known approaches.

Advantageous examples are specified in the following description, each of which can represent aspects of the disclosure as such or in (sub-) combination. Some features are explained with regard to methods, others with regard to devices. The corresponding aspects are to be mutually transferred in a corresponding manner, however.

According to one aspect, some portions of the disclosure relate to a method for determining a position of a vehicle. The vehicle has at least one navigation sensor, a communication device, and a control device. The control device is coupled at least with the navigation sensor and the communication device. The method comprises at least the following steps:

At least one position signal of a global navigation satellite system (GNSS) is received by the navigation sensor.

An estimated vehicle position is determined by the control device based on the at least one received position signal.

An estimated relative velocity of the vehicle with respect to the GNSS is determined by the control device at least based on multiple received position signals of the GNSS.

Correction values for the estimated vehicle position and the estimated relative velocity are received by the control device from a server based on the communication device.

A corrected vehicle position and a corrected relative velocity are determined by the control device based on the received correction values. At least one of a pseudo-range, a Doppler shift, and a measured vehicle velocity is taken into consideration by the control device in the determination of the corrected vehicle position and the corrected relative velocity.

The method utilizes the approach that some physical effects and variables can be used to increase the accuracy of the position determination. For example, the utilization of the Doppler effect permits a reduction of the position inaccuracy.

Advantageously, no separate specialized components which have to be used as reference objects are required to increase the accuracy of the position determination. Rather, the method is advantageously based on the fact that in principle any vehicle which can execute the method can be used as a reference object, as described in detail hereinafter. The determined correction values can then be transmitted to all vehicles, which can once again determine a corrected vehicle position and a corrected relative velocity on the basis of the correction values. A low-expenditure method for position determination is thus provided, which enables a high level of accuracy, however. The method can thus be used for many applications, for example for automatic or autonomous driving functionalities.

The pseudo-range is to be understood approximately as the distance between a transmitter and a receiver, which results solely from the time-of-flight of the radio signal. The transmitted signal has a timestamp of the transmission time. The receiver compares this timestamp to the time of the reception of the signal. Assuming a linear transmission path between transmitter and receiver, the pseudo-range can be determined on the basis of the speed of light. Since the transmission path is generally not linear (see above-mentioned interference effects), the pseudo-range thus determined does not correspond to the real distance between transmitter and receiver.

The Doppler shift is to be understood as the time compression or elongation of a signal in the event of changes of the distance between transmitter and receiver during the duration of the signal. The effect is based on the relative velocity between transmitter and receiver.

According to one aspect, some portions of the disclosure relate to a control system for determining a position of a vehicle. The vehicle has at least one navigation sensor, a communication device, and a control device. The control device is at least coupled with the navigation sensor and the communication device. The control system is configured to execute the method according to one of the preceding claims. The advantages which are achieved by the method described herein are also implemented in a corresponding manner by the control system presented here.

The control device may solve a single combined position-dependent and velocity-dependent optimization task to determine the corrected vehicle position and the corrected relative velocity. The optimization task is thus no longer under defined, so that state variables can be determined with high precision for each control period.

In some examples, one or more of the pseudo-range, the Doppler shift, and the measured vehicle velocity are taken into consideration by the control device in the determination of the corrected vehicle position and the corrected relative velocity. Due to the combination of pseudo-range and Doppler shift, it is possible to combine the vehicle position optimization task and the vehicle velocity optimization task to form a single combined optimization task. An increase of the accuracy of the position determination in relation to the consideration of only one aspect is thus enabled.

In one theoretical approach, a method of least squares can be applied to minimize the following optimization task:

$${\sum }_{i} {( \frac{‖ {\vec{x}}_{i} - \vec{y} ‖ - {ρ}_{i} + b}{Δ {ρ}_{i}} )}^{2}$$

In this case, \vec{x}ᵢ describes the satellite positions (which are known), \vec{y} describes the position of the navigation sensor of the vehicle that receives the position signal, rᵢ=∥\vec{x}ᵢ−\vec{y}∥ describes the (real) distances between the respective satellite and the navigation sensor, and ρᵢ=rᵢ+b describes the pseudo-range between the respective satellite and the navigation sensor.

The pseudo-range comprises the unknown difference between the vehicle system clock b and the “real” system time, which is defined by the system clock of the respective satellite. This means that the unknowns are given by y and b, thus the actual “real” position of the navigation sensor and the difference between the vehicle system clock and the “real” system time.

In addition, Δρᵢ represent weighting factors for each received position signal, for example with respect to different satellites.

The offset correction results for each satellite i from the following equation:

$${ϵ}_{i} = {ρ}_{i} - ‖ {\vec{x}}_{i} - \vec{{y}_{s}} ‖ - {b}_{s}$$

In this case, (\vec{y}ₛ, b) are the solution of the above-mentioned optimization task.

The correction values for the position determination and the velocity determination can be determined by the determination of the Doppler shift.

The Doppler shift of a specific signal is the time derivative of its carrier phase. The Doppler shift is therefore primarily determined by the relative velocity between the antennas of the satellite of the GNSS and of the navigation sensor of the vehicle as well as by a common offset, which is proportional to the clock frequency error of the navigation sensor (or the vehicle system clock).

The second optimization task for determining the vehicle velocity is therefore defined as follows:

$${v}_{los , i} = ( {\vec{v}}_{sat , i} - \vec{v} ) \cdot {\hat{r}}_{i}$$

In this case, v_{los,i} is the velocity of the navigation sensor, which is projected in the direction of the satellite i. This velocity is also referred to as the line-of-sight velocity. In addition, \vec{r}ᵢ is a unity vector, which points from the navigation sensor of the vehicle toward the satellite i:

$${\vec{r}}_{i} = {\vec{x}}_{i} - \vec{y} \\ {\hat{r}}_{i} = \frac{{\vec{r}}_{i}}{‖ {\vec{r}}_{i} ‖}$$

A method of least squares is used to determine the vehicle velocity:

$${\sum }_{i} {( \frac{( {\vec{v}}_{sat , i} - \vec{v} ) \cdot {\hat{r}}_{i} - {v}_{los , i} - {v}_{b}}{Δ {v}_{los , i}} )}^{2}$$

In this case, Δv_{los,i} are weighting factors for each received position signal. As a result, a single combined optimization task can be defined, which is to be minimized:

$${\sum }_{i} {( \frac{‖ {\vec{x}}_{i} - \vec{y} ‖ - {ρ}_{i} + b}{Δ {ρ}_{i}} )}^{2} + {( \frac{( {\vec{v}}_{sat , i} - \vec{v} )}{Δ {v}_{los , i}} \frac{\partial ‖ {\vec{x}}_{i} - \vec{y} ‖}{\partial ( {\vec{x}}_{i} - \vec{y} )} + \frac{{v}_{b}}{Δ {v}_{los , i}} - \frac{{v}_{los , i}}{Δ {v}_{los , i}} )}^{2}$$

The unknown variables are given here by \vec{y}, thus the actual “real” position of the navigation sensor, by b, thus the clock divergence of the vehicle system clock with respect to the system clock of the satellite of the GNSS, and by v_{b}, thus the “real” vehicle velocity. These can be determined by the method of least squares.

Therefore, measured values of a vehicle velocity sensor can be used to increase the precision in the determination of the vehicle position and the clock divergence of the vehicle system clock in relation to the system clock of the GNSS. This also iteratively permits the increase of the precision in the determination of the vehicle velocity. In this regard, it is apparent from the individual combined optimization task that for a stationary vehicle or a vehicle having constant relative velocity (line-of-sight velocity) with respect to the satellite of the GNSS, the next-to-last term is omitted or is constant. The position inaccuracy in the position determination of the vehicle and the inaccuracy of the determination of the real system clock time of the vehicle system clock can therefore be reduced. The determination of the vehicle velocity can also be achieved with increased precision on the basis of the position determination and vehicle system clock time determination which have been made more precise.

A vehicle position of the vehicle, the control device of which has determined the correction values, is optionally assigned to the correction values. Position-dependent differences between the correction values can thus be determined.

The correction values may be valid for a range around the vehicle position assigned to the correction values. In particular, the correction values are valid provided that a distance between a vehicle position of a vehicle in question and the vehicle position assigned to the correction values falls below a distance threshold value. The distance threshold value can be, for example, 50 km or less (e.g., 35 km or less or 25 km or less).

In some examples, the control device transmits the corrected vehicle position and the corrected relative velocity based on the communication device to the server. A central point is thus created at which all items of information about the respectively determined correction values can be collected.

The correction values provided by the server may be position-dependent and satellite-dependent. The server continuously updates a map of the position-dependent and satellite-dependent correction values.

The server can optionally have a database.

The database may be configured to have a list of satellite-dependent and position-dependent correction values. A satellite-dependent and position-dependent map system can thus be created. For a corresponding vehicle, its position can then be used to determine correction values which have validity at this position. For example, correction values can be selected to which a vehicle position is assigned, which have a distance to the vehicle position of the vehicle in question that is less than 25 km.

In some examples, the vehicle has at least one velocity sensor, which is coupled with the control device. The control device transmits the corrected vehicle position and the corrected relative velocity to the server at least if the control device determines based on at least one measured value of the velocity sensor that the vehicle is stationary or moves at constant overland velocity (also called line-of-sight velocity). In this case, it is possible to exclude that the relative velocity of the vehicle in relation to the one or the multiple satellites of the GNSS changes during the signal transmission and the position determination. Therefore, in particular in the case of the standstill or the constant overland velocity, the corrected vehicle parameters (corrected vehicle position and corrected relative velocity) can be transmitted to the server. Updated correction values can then be determined and stored by the server on the basis of the corrected vehicle parameters.

Alternatively or additionally, updated correction values can be determined by the vehicle on the basis of the corrected vehicle position in the corrected relative velocity if the control device determines, based on at least one measured value of the velocity sensor, that the vehicle is stationary or moves at constant overland velocity. In this case, the updated correction values can also be transmitted to the server by the vehicle.

Depending on whether the server or the control device of the vehicle executes the determination of the updated correction values, the computing effort for the respective other device can be reduced.

The method utilizes the effect that any vehicle which is stationary or moves at constant overland velocity can be used as a reference object for vehicles moving inconsistently. The accuracy in the determination of the corrected vehicle positions and the corrected relative velocities of the vehicles moving inconsistently can thus advantageously be increased.

The control device may determine the corrected vehicle position and the corrected relative velocity additionally at least based on a measured value of the velocity sensor. The precision of the position and relative velocity determination is thus increased. For example, it is thus known whether the vehicle moves at a constant relative velocity relative to the at least one satellite of the GNSS. This has influence on the determination of the Doppler shift.

In some examples, the velocity sensor can comprise at least one of a radar, a wheel rotational encoder, a camera, or a LiDaR. These sensor types are suitable for detecting the vehicle velocity with high precision.

The control device optionally determines the estimated relative velocity of the vehicle additionally at least based on a measured value of the velocity sensor. The determination of the estimated relative velocity is thus particularly simple, since it only has to be based on the measured value of the velocity sensor with knowledge of the flight path of the at least one satellite of the GNSS.

In some examples, the control device additionally receives topographic map information or a vehicle trajectory from the server or a trajectory planner. The control device determines the corrected vehicle position and the corrected relative velocity of the vehicle additionally at least based on the topographic map information or the vehicle trajectory. The precision of the determination of the corrected vehicle parameters can thus be further increased, for example, in that topographic special features are taken into consideration.

The control device furthermore optionally determines at least one vehicle velocity vector based at least on the corrected vehicle position and the corrected relative velocity. The status of the vehicle can then be determined more precisely. This can be used, for example, for specialized driving functionalities, such as lane change assistants, lane change assistants, or automated or autonomous functionalities.

The correction values may comprise at least time shifts between a system clock of the vehicle (vehicle system clock) and a system clock of the GNSS. The estimated values can be corrected on the basis of the time shifts, since the running time difference between the vehicle system clock and the system clock of the GNSS is then determined. The determination of the pseudo-range and the Doppler shift can thus be corrected, which then also has an effect on the correction of the vehicle position and the relative velocity. The precision of the position determination is thus increased.

The system clock of the GNSS particularly may relate to a system clock of at least one satellite or a device coupled therewith.

In some examples, the corrected vehicle position and the corrected relative velocity are used to control driving functionalities of the vehicle, in particular for autonomous driving functionalities. For example, the control device can be coupled with a driving control device, which carries out such driving functionalities, for example an automatic parking system or a virtual towing maneuver.

The method may be configured to enable a determination of the position of the vehicle with a position inaccuracy of 30 cm or less (e.g., 10 cm or less, 5 cm or less, or 1 cm or less). Autonomous driving functionalities are thus enabled which require a position accuracy at the lane level or even beyond.

In some examples, the method is refined in that the correction values are also transmitted from the server to other devices coupled with the server. The correction values can then be used by the devices at least in order to determine corrected device positions.

For example, the devices coupled with the server can be mobile telephones, tablets, or devices of the Internet of Things, which have a navigation sensor, a control device, and a communication device. The area of application of the method is thus advantageously enlarged.

The method is optionally designed as a computer-implemented method. This means that the control mechanisms can be executed with the aid of one or more data processing devices.

According to a further aspect, the disclosure also relates to a computer program product, comprising commands which, upon execution of the program by a computer, prompt it to carry out the method as described herein. The advantages achieved by the method described herein are also achieved in a corresponding manner by the computer program product.

According to an additional aspect, the disclosure also relates to a computer-readable storage medium, comprising commands which, upon the execution of the program by a computer, prompt it to carry out the method as described herein. The advantages achieved by the method described herein are also achieved in a corresponding manner by the computer-readable storage medium.

According to one aspect, some portions of the disclosure relate to a vehicle having a control system as described herein. The advantages achieved by the control system described herein are also implemented in a corresponding manner by the vehicle presented here.

In the meaning of the disclosure, vehicles can in particular comprise land vehicles, namely, among other things, off-road vehicles and road vehicles such as passenger vehicles, buses, trucks, and other utility vehicles. Vehicles can be manned or unmanned.

All features explained with regard to the various aspects are combinable individually or in (sub-) combination with other aspects.

The following detailed description in conjunction with the appended drawings, in which identical numbers indicate identical elements, is intended to be a description of various embodiments of the disclosed subject matter and is not to represent the only embodiments. Any embodiment described in this disclosure is used solely as an example or illustration and is not to be interpreted as preferred or advantageous in relation to other embodiments. The illustrative examples contained herein do not make any claim of completeness and do not limit the claimed subject matter to the precise disclosed forms. Various modifications of the embodiments described are readily recognizable to a person skilled in the art and the general principles defined herein can be applied to other embodiments and applications without deviating from the spirit and scope of the described embodiments. The described embodiments are therefore not limited to the embodiments shown, but rather have the greatest possible area of application compatible with the principles and features disclosed here.

All features disclosed hereinafter with respect to the examples and/or the appended figures can be combined alone or in any subcombination with features of the aspects of the disclosure, including features of other examples, presuming that the resulting combination of features is reasonable for a person skilled in the art in the area of technology.

For the purposes of the disclosure, the wording “at least one of A, B, and C” means, for example, (A), (B), (C), (A and B), (A and C), (B and C), or (A, B and C), including all further possible combinations if more than three elements are listed. In other words, the term “at least one of A and B” generally means “A and/or B”, namely “A” alone, “B” alone, or “A and B”.

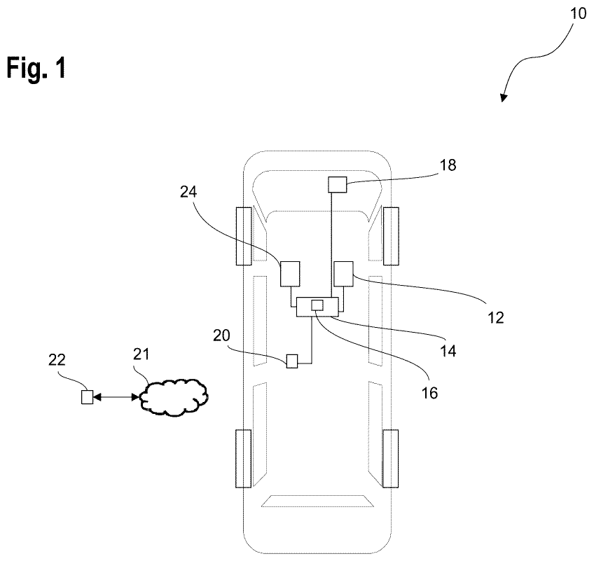

FIG. 1 shows a simplified schematic representation of a vehicle 10.

The vehicle 10 has a navigation sensor 12 and a control device 14. The control device 14 comprises a vehicle system clock 16. In addition, the vehicle 10 has a velocity sensor 18, in the form of a LiDaR sensor here. Moreover, the vehicle 10 comprises a communication device 20.

The control device 14 is coupled at least with the navigation sensor 12, the velocity sensor 18, and the communication device 20.

The communication device 20 is configured such that the control device 14 can communicate, in particular bidirectionally, via the communication device 20 with a server 22. In the present case, the communication is made possible via the Internet 21.

In this example, the vehicle 10 additionally has a trajectory planner 24, which is also coupled with the control device 14. A route of the vehicle 10 which has been covered or is to be covered can be defined by means of the trajectory planner 24.

Due to the communication with the control device 14, the control device 14 can receive route information and/or topographical map information with respect to the vehicle trajectory of the vehicle 10 from the trajectory planner 24.

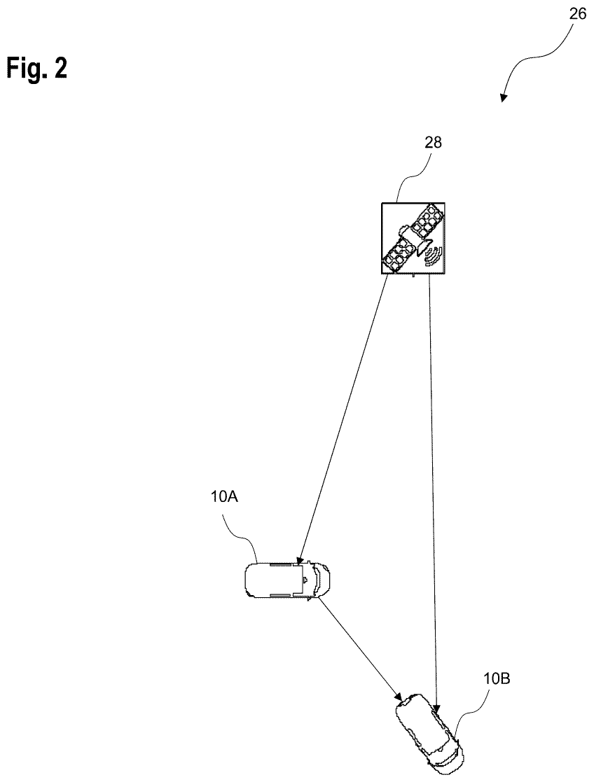

FIG. 2 shows a simplified schematic representation of an application scenario 26.

A satellite 28 of a global navigation satellite system (GNSS) communicates both with stationary vehicles 10A and with moving vehicles 10B.

The moving vehicle 10B in particular has a varying relative velocity with respect to the satellite 28 here.

In contrast, the relative velocity of the stationary vehicle 10A is constant in relation to the satellite 28 and is only influenced by the movement of the satellite 28.

Due to the constant relative velocity of the stationary vehicle 10A with respect to the satellite 28 of the GNSS, the stationary vehicle 10A can be used as a reference object within the method explained in detail hereinafter. The vehicle 10A can therefore determine correction values for the position determination and velocity determination and provide them at least indirectly to the moving vehicle 10B.

If a distance between the moving vehicle 10B and the stationary vehicle 10A falls below a distance threshold value, 25 km here, these correction values determined by the stationary vehicle 10A can be applied for the position and velocity determination of the moving vehicle 10B. Therefore, the correction values determined by the stationary vehicle 10A can be provided at least indirectly, for example via the server 22, to the moving vehicle 10B.

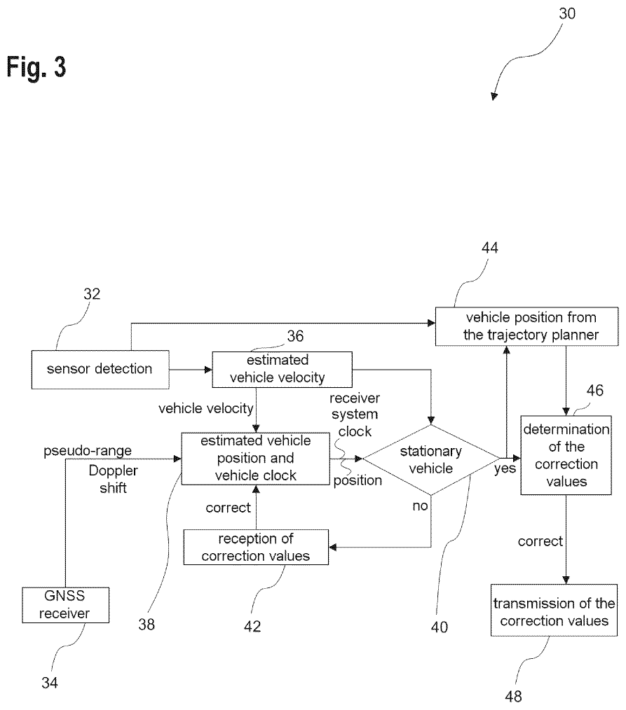

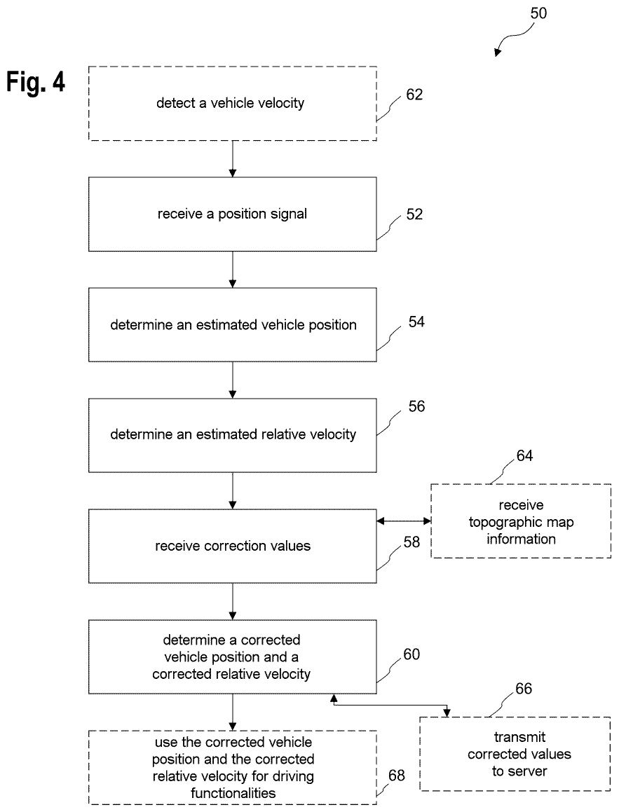

FIG. 3 shows a simplified schematic representation of a flow chart 30 of the method 50. In this context, FIG. 4 shows a simplified schematic representation of a method 50. Additional possible steps are represented by dashed lines.

In step 62 of the method 50 (corresponding to step 32 in the flow chart 30), a vehicle velocity is detected on the basis of a velocity sensor 18. For this purpose, for example, a speed sensor, a radar sensor, a LiDaR sensor, or an image-based camera sensor can be used.

In step 52 of the method 50, at least one position signal of the GNSS is received by the navigation sensor 12. In the flow chart 30, this corresponds to step 34.

On the basis of the position signal received in step 52, the pseudo-range and the Doppler shift between the vehicle 10 and the relevant satellite 28 of the GNSS can be determined, in particular on the basis of the above-explained optimization task by means of a method of least squares.

As a result, in step 54 of the method 50 (corresponding to step 38 of the flow chart 30), an estimated vehicle position can be determined based on the vehicle system clock 16. In particular, the estimated vehicle position can be determined by the control device 14. The estimated vehicle position is initially only based on the at least one received position signal of the satellite 28 of the GNSS.

In step 56 of the method 50 (corresponding to step 36 of the flow chart 30), an estimated vehicle relative velocity of the vehicle 10 relative to the satellite 28 of the GNSS can be determined, in particular by the control device 14.

The determination of the estimated vehicle relative velocity can be based on various approaches. For example, the determination of the vehicle relative velocity is already possible based on multiple position signals which the vehicle 10 receives from different satellites 28 of the GNSS.

Alternatively, the estimated vehicle relative velocity can also be based on a measured value of a velocity sensor 18 of the vehicle 10.

In a further alternative, these aspects can be combined. This means that the estimated vehicle relative velocity is based both on at least one received position signal of a satellite 28 of the GNSS and on a measured value of a velocity sensor 18.

The precision of the determination of the estimated vehicle relative velocity is increased here by the consideration of a measured value of a velocity sensor 18 of the vehicle 10.

In the flow chart 30, it is now made clear in step 40 that the control device 14 is configured to continue the method 50 depending on whether the vehicle 10 is stationary or has a constant relative velocity (line-of-sight velocity) relative to the satellite 28 of the GNSS or whether the vehicle 10 has a varying relative velocity.

If the vehicle 10 has a varying relative velocity relative to the satellite 28 of the GNSS, the vehicle 10 thus receives, in step 58 of the method 50, correction values for the estimated vehicle position and the estimated relative velocity by the control device 14 from a server 22 based on the communication device 20. This corresponds to step 42 in the flow chart 30.

As a result, in step 60 of the method 50 (corresponding to step 38 of the flow chart 30), a corrected vehicle position and a corrected relative velocity of the vehicle 10 can be determined by the control device 14 based on the received correction values. In particular, the determined pseudo-range and the determined Doppler shift can be corrected on the basis of the received correction values, by which the precision for determining the corrected vehicle position and the corrected vehicle relative velocity is increased.

It is made clear in particular in the flow chart 30 that the corrected vehicle position and the corrected vehicle relative velocity can be used in order to determine, starting from step 38 in step 40, for the case of the vehicle 10 which is not (any longer) moving, updated correction values with respect to the vehicle position, the vehicle relative velocity, and the vehicle system clock.

If it is established in step 40 that the vehicle 10 is now not (any longer) moving, but rather stationary, the actually determined correction values (see step 46 of the flow chart 30) for the now stationary vehicle 10A can then be transmitted to the server 22. This corresponds to step 66 of the method 50.

A position determination having a position inaccuracy of less than or equal to 1 cm is ensured by the method 50.

Therefore, according to step 68 of the method 50, the corrected values for the vehicle position and the vehicle relative velocity can be used in the vehicle control to carry out automated or autonomous driving functionalities, for example in the context of an automatic parking system or an autonomous lane change assistant. The control device 14 can be configured to transmit the corresponding corrected vehicle parameters to a vehicle control device.

Optionally, information from the control device 14 which is based on the trajectory planner 24 can be taken into consideration in the determination of the correction values in step 44 of the flow chart 30 (corresponding to step 64 of the method 50). For example, the information can comprise topographic map information or a vehicle trajectory. The precision for the determination of the updated correction values can thus be increased. The vehicle trajectory covered can be determined here by the trajectory planner 24, for example, based on the measured values of the velocity sensor 18 from step 32 of the flow chart.

A vehicle position can be assigned to the correction values determined by the vehicle 10. For example, the vehicle position can indicate the position at which the vehicle 10 has come to a standstill.

The server 22 can have a database which comprises position-dependent and satellite-dependent correction values for the position determination and the determination of the vehicle relative velocity.

If a request is then placed to the server 22 by a vehicle 10 with respect to relevant correction values, the vehicle position of the vehicle 10 placing the request can be compared to the database and as a result those correction values can be selected for which the distance between the vehicle position assigned to the correction values and the vehicle position of the vehicle placing the request falls below a distance threshold value. In the present case, the difference threshold value is 25 km.

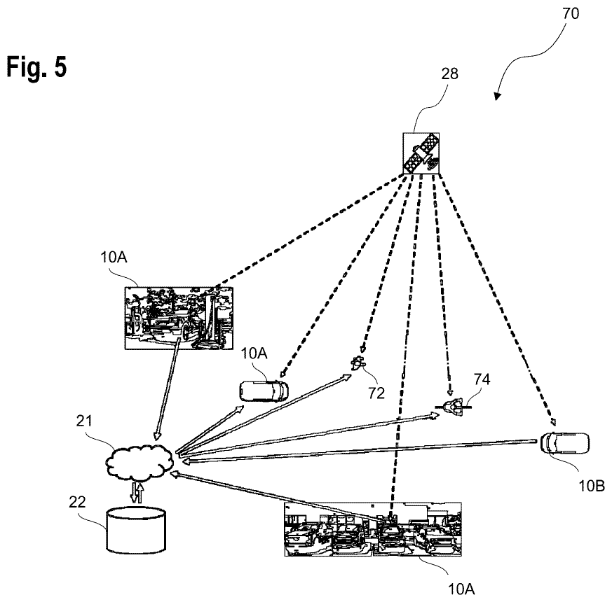

FIG. 5 shows a simplified schematic representation of a further application scenario 70.

The database created by the server 22 can in particular be used not only for vehicles 10, but also by other devices in order to increase the precision in the determination of position and velocity. The corresponding devices have a navigation sensor for receiving position signals of a satellite 28 of the GNSS, a control device, and a communication device, by means of which they can communicate with the server 22.

For example, pedestrians 72 can have smartphones which can communicate with the server 22 via the Internet 21 in order to receive corresponding correction values.

Alternatively or additionally, for example, bicyclists 74 can have corresponding devices, on the basis of which they can increase the precision of the position determination and the determination of a relative velocity.

Specific examples disclosed here, in particular of the control device 14, use circuits (for example, one or more circuits), in order to implement standards, protocols, methods, or technologies disclosed here, to functionally couple two or more components, to generate information, to process information, to analyze information, to generate signals, to code/decode signals, to convert signals, to transmit and/or to receive signals, to control other devices, etc. Circuits of any type can be used.

In one example, a circuit such as the control device comprises, among other things, one or more data processing devices such as a processor (for example, a microprocessor), a central processor unit (CPU), a digital signal processor (DSP), an application-specific integrated circuit (ASIC), a field-programmable gate array (FPGA), a system-on-a-chip (SoC), or the like or any combinations thereof and can comprise discrete digital or analog circuit elements or electronics or combinations thereof. In one example, the circuit comprises hardware circuit implementations (for example implementations in analog circuits, implementations in digital circuits, and the like, as well as combinations thereof).

In one example, circuits comprise combinations of circuits and computer program products with software or firmware instructions which are stored on one or more computer-readable memories and interact in order to prompt a device to execute one or more of the protocols, methods, or technologies described here. In one example, the circuit technology comprises circuits, such as microprocessors or parts of microprocessors, which require software, firmware, and the like for operation. In one example, the circuits comprise one or more processors or parts thereof and the associated software, firmware, hardware, and the like.

Reference can be made in this disclosure to amounts and numbers. If not expressly indicated, such amounts and numbers are not to be viewed as limiting, but rather as examples of the possible amounts or numbers in conjunction with the disclosure. In this context, the term “plurality” can also be used in the disclosure in order to indicate an amount or number. In this context, the term “plurality” means any number which is greater than one, such as two, three, four, five, etc. The terms “about”, “approximately”, “nearly”, etc. mean plus or minus 5% of the specified value.

Although the disclosure has been illustrated and described in reference to one or more examples, a person skilled in the art will be able to perform equivalent changes and modifications after reading and understanding this description and the appended drawings.

1.-13. (canceled)

14. A control system comprising a control device of a vehicle, the control device programmed to:
receive at least one position signal of a global navigation satellite system by way of a navigation sensor of the vehicle;
determine an estimated vehicle position based on the at least one received position signal;
determine an estimated relative velocity of the vehicle with respect to the global navigation satellite system at least based on multiple received position signals of the global navigation satellite system;
receive correction values for the estimated vehicle position and the estimated relative velocity from a server based on a communication device of the vehicle; and
determine a corrected vehicle position and a corrected relative velocity based on the received correction values, wherein at least one of a pseudo-range, a Doppler shift, and a measured vehicle velocity is taken into consideration by the control device.

15. The control system of claim 14, wherein the control device is further programmed to transmit the corrected vehicle position and the corrected relative velocity based on the communication device to the server.

16. The control system of claim 15, wherein the correction values provided by the server are position-dependent and satellite-dependent, and the server continuously updates a map of the position-dependent and satellite-dependent correction values.

17. The control system of claim 14, wherein the vehicle includes at least one velocity sensor, which is coupled with the control device, and wherein the control device is further programmed to transmit the corrected vehicle position and the corrected relative velocity to the server at least when the control device determines based on at least one measured value of the velocity sensor that the vehicle is stationary or moves at a constant overland velocity.

18. The control system of claim 17, wherein the control device is further programmed to determine the corrected vehicle position and the corrected relative velocity additionally at least based on a measured value of the velocity sensor.

19. The control system of claim 17, wherein the control device is further programmed to determine the estimated relative velocity of the vehicle additionally at least based on a measured value of the velocity sensor.

20. The control system of claim 14, wherein the control device is further programmed to receive topographic map information or a vehicle trajectory from the server or a trajectory planner, and determine the corrected vehicle position and the corrected relative velocity of the vehicle additionally at least based on the topographic map information or the vehicle trajectory.

21. The control system of claim 20, wherein the control device is further programmed to determine at least one vehicle velocity vector based at least on the corrected vehicle position and the corrected relative velocity.

22. The control system of claim 21, wherein the control device is further programmed to solve a single combined position-dependent and velocity-dependent optimization task to determine the corrected vehicle position and the corrected relative velocity.

23. The control system of claim 22, wherein the correction values comprise at least time shifts between a vehicle system clock of the vehicle and a system clock of the global navigation satellite system.

24. The control system of claim 23, wherein the corrected vehicle position and the corrected relative velocity are used to control driving functionalities of the vehicle.

25. The control system of claim 14, further comprising the navigation sensor and the communication device, wherein the control device is coupled at least with the navigation sensor and the communication device.

26. The control system of claim 14, wherein the pseudo-range is taken into consideration by the control device when determining the corrected vehicle position and the corrected relative velocity.

27. The control system of claim 14, wherein the Doppler shift is taken into consideration by the control device when determining the corrected vehicle position and the corrected relative velocity.

28. The control system of claim 14, wherein the measured vehicle velocity is taken into consideration by the control device when determining the corrected vehicle position and the corrected relative velocity.

29. A method comprising:
receiving at least one position signal of a global navigation satellite system by way of a navigation sensor of the vehicle;
determining an estimated vehicle position by way of a control device of the vehicle based on the at least one received position signal;
determining an estimated relative velocity of the vehicle with respect to the global navigation satellite system by way of the control device at least based on multiple received position signals of the global navigation satellite system;
receiving correction values for the estimated vehicle position and the estimated relative velocity by way of the control device from a server based on a communication device of the vehicle; and
determining a corrected vehicle position and a corrected relative velocity by way of the control device based on the received correction values, wherein at least one of a pseudo-range, a Doppler shift, and a measured vehicle velocity is taken into consideration by the control device.

30. The method of claim 29, wherein the pseudo-range is taken into consideration by the control device when determining the corrected vehicle position and the corrected relative velocity.

31. The method of claim 29, wherein the Doppler shift is taken into consideration by the control device when determining the corrected vehicle position and the corrected relative velocity.

32. The method of claim 29, wherein the measured vehicle velocity is taken into consideration by the control device when determining the corrected vehicle position and the corrected relative velocity.

33. The method of claim 29, further comprising solving a single combined position-dependent and velocity-dependent optimization task by way of the control device to determine the corrected vehicle position and the corrected relative velocity.
